(19) United States
(12) Patent Application Publication
(10) Pub. No.: US 2004/0181948 A1
(43) Pub. Date: Sep. 23, 2004

(54) Lockable knife block

(76) Inventors: Nicholas Bernard Basden, London (GB); Stephen Boyd Ratchye, Venice, CA (US)

Correspondence Address: NICHOLAS BASDEN, 13 BUCKINGHAM MANSIONS, 353 WEST END LANE, LONDON, NW6 1LR, GB

(21) Appl. No.: 10/389,598

(22) Filed: Mar. 17, 2003

(51) Int. Cl. B26B 27/00

(52) U.S. Cl. 30/298

(57) ABSTRACT

The lockable knife block is designed to hinder young children from extracting knives when not supervised or aided by an adult. When the safety-lock cap is in the locked position, knives' handles are inaccessible. When the safety-lock cap is lowered to the open position, the knives are available for use. The locking mechanism is difficult for small children to operate, and greatly enhances overall kitchen safety.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM

### LISTING COMPACT DISK APPENDIX

Not Applicable

### BACKGROUND OF THE INVENTION

This invention is a knife block that can be locked to safeguard knives and other sharp objects (e.g., kitchen shears) from small children. This invention utilizes a locking mechanism that does not require any alterations to the knives nor the purchase of new knives, both considerations with other lockable knife blocks.

### BRIEF SUMMARY OF THE INVENTION

This invention is a knife block that can be locked to safeguard knives and other sharp objects (e.g., kitchen shears) from small children. In the unlocked position, a cap with slots fits over the block base. The slots in the cap are aligned with the slots in the base such that the knives' handles protrude through the cap and the knives are available for use. To lock the knife block, the user raises the cap above the knives' handles and rotates it, confining the knives within the cap because of the changed orientation of the slots, i.e., perpendicular to the knives' handles. Catch pieces lock the cap in place. To unlock it again, the user depresses the catch pieces and rotates and lowers the cap.

### BRIEF DESCRIPTION OF THE SEVERAL VIEWS OF THE DRAWING

FIG. 1 shows the base with its slots for the knives on top, grooves for the pegs of the cap piece, and toward the back, one of the two catch pieces.

FIG. 2 shows the cap piece with pegs, and the slots in the cap for the knives.

FIG. 3 shows the knife block in the locked position.

FIG. 4 shows the knife block in the unlocked position with knives protruding through the slots in the cap.

FIG. 5 shows a top view of the knife block with the slots in the cap aligned with the knives.

FIG. 6 shows a top view of the knife block with the slots in the cap rotated 90 degrees out of alignment with the knives, i.e., perpendicular to the knives' handles.

FIG. 7 shows one of the catch pieces on the base.

FIG. 8 shows a detailed perspective of one of the catch pieces.

### DETAILED DESCRIPTION OF THE INVENTION

1. The lockable knife block is manufactured in two parts.

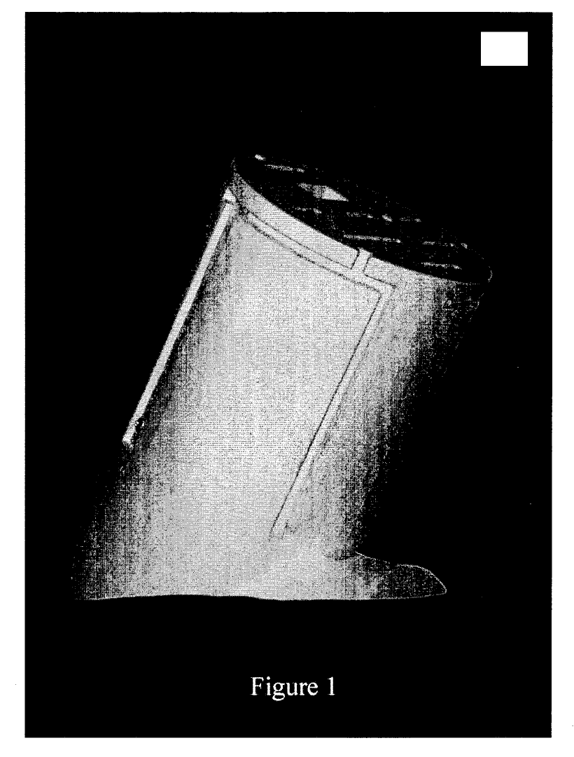

2. First, the base or body of the knife block is made of pressed wood or a plastics polymer. The base has slots for the knives' blades like most knife blocks. The upper part of the base is cylindrical. On the sides of the upper part of the base there are three sets of narrow flat grooved channels. Pegs in the cap piece slide in these grooves, guiding the movement of the cap. Two catch pieces cross the grooved channels, and these hold the pegs to lock the cap in place. (See FIG. 1) The grooved channels and catch pieces receive further discussion below. A “foot” projects from the front of the base for stability. The back of the base, opposite the foot, is truncated to allow the knife block to be placed against the back wall of a kitchen countertop.

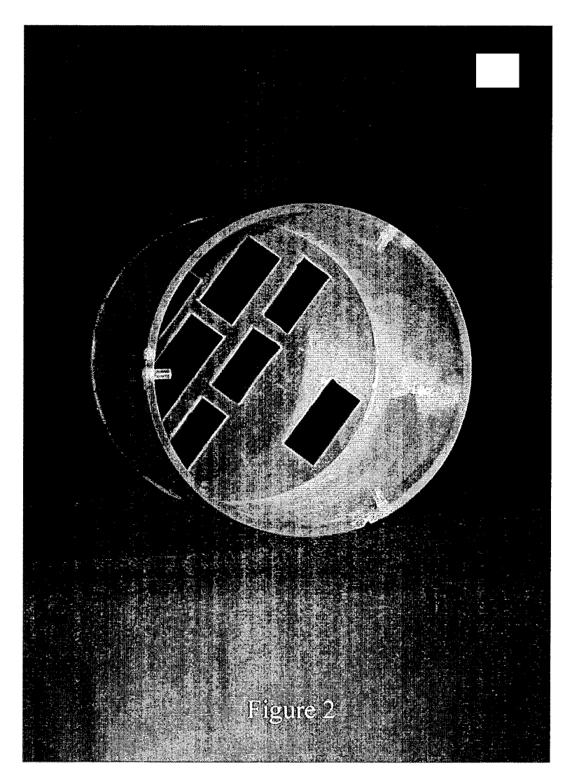

3. The second part of the knife block is the cap, and it is made of a clear or translucent plastic polymer of a depth and circumference to fit snugly around the cylindrical part of the base. (See FIG. 2) The cap has slots in its top that are slightly larger than the knives' handles. Three peg pieces at the bottom of the cap fit into the grooves in the base to guide its motion. The pegs are spaced equally around the bottom of the cap. Specifically, if the bottom of the base piece is visualized as a clock, the pegs are placed at 12 o'clock, 4 o'clock and 8 o'clock.

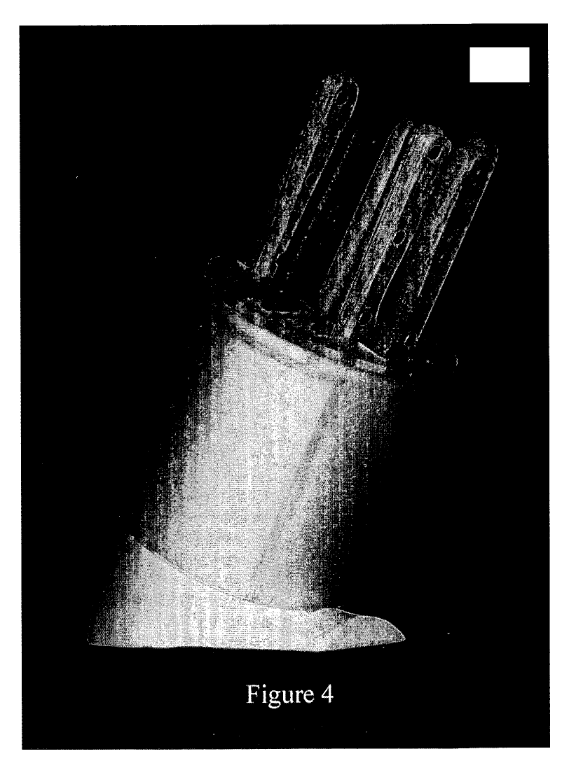

4. In the unlocked position, the cap fits down over the base with the knives' handles protruding through the slots in the cap. (See FIG. 4) In this position, the knives are accessible to the user.

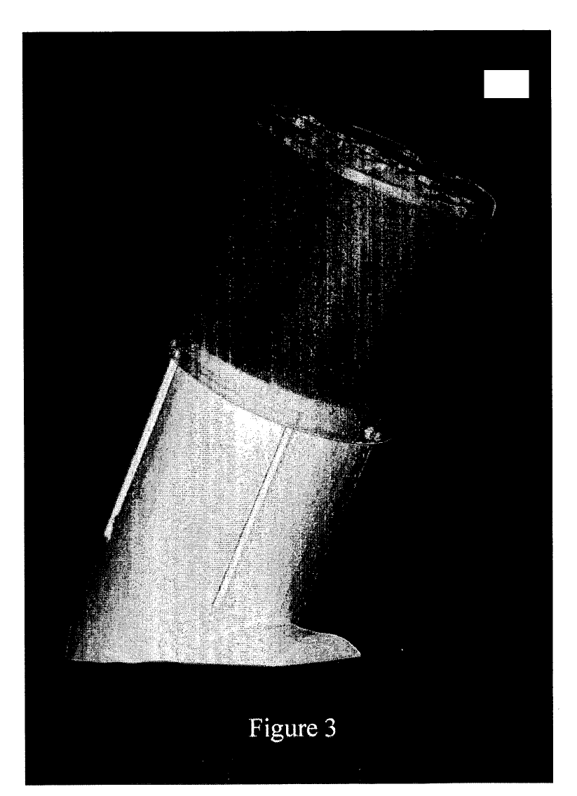

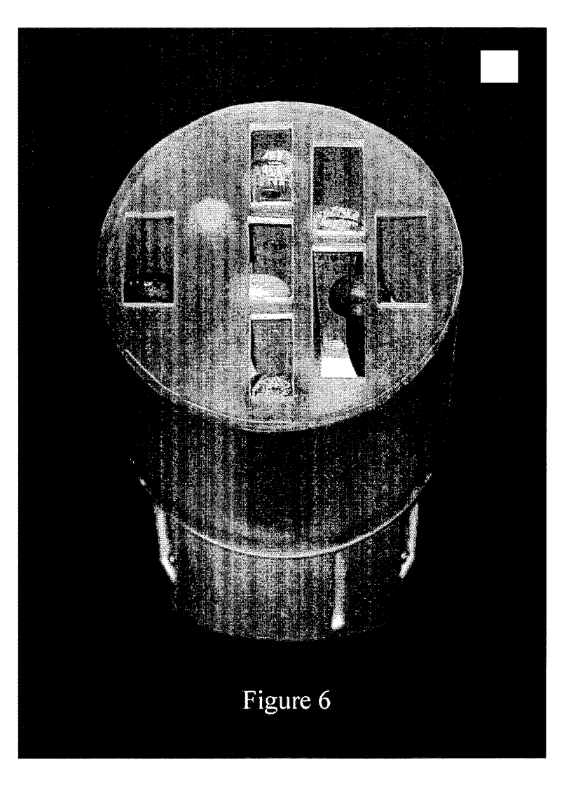

5. To lock the knife block, the user raises the cap and rotates it 90 degrees. This motion is guided by the cap pegs sliding along the grooves in the base. Once the cap is raised and rotated, the knives' handles are then completely inside the cap and the slots are oriented so that the knives' handles cannot pass through them. (See FIG. 3 and FIG. 6) When the cap is moved to the locked position, two “catch” pieces hold the cap pegs in place and restrict the cap movement.

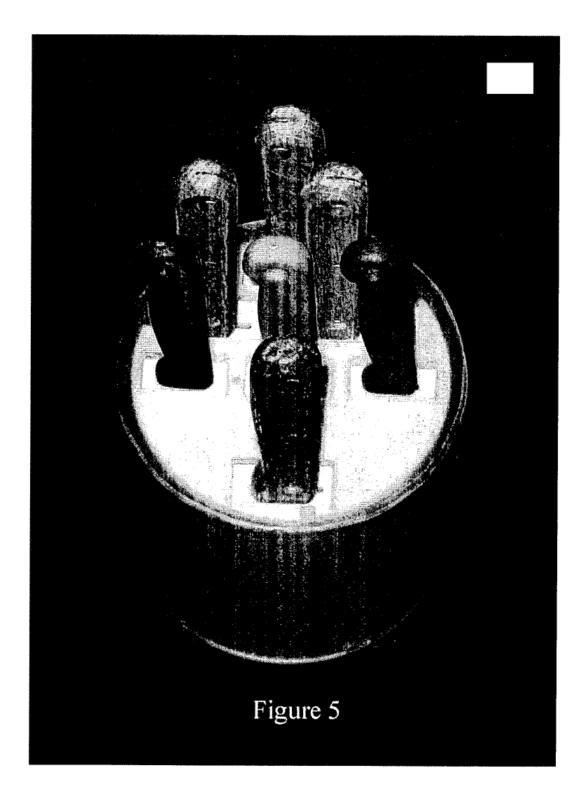

6. To unlock the block, the user depresses the catch pieces with thumb and forefinger and rotates the cap backwards 90 degrees with the other hand. At this point, the orientation of the slots in the cap matches the knives' handles, so that the cap can be lowered to fit down over the base, making the knives accessible. (See FIG. 5)

7. The grooves in the base that accommodate the cap pegs are roughly 5 millimeters wide and deep. These three sets of grooves are spaced equally around the circumference of the base to match the cap pegs. Each set of grooves has the configuration of an upside-down “L.” (See FIG. 1) One leg of the L runs along the axis of the cylinder, or up and down—call this the longitudinal leg. The top leg of the L runs around the circumference of the cylinder. The top legs are about 5 millimeters below the top of the base. When the block is in the unlocked position, the pegs are at the bottom of the longitudinal groove. As the block is unlocked, the pegs of the cap move upward along the longitudinal groove until they hit the corner of the L. Then, the cap is rotated so the pegs move along the top leg of the L until it reaches the end of that groove. When the cap is in this position, the slots in the cap have a changed orientation and the knives' handles cannot pass through. (See FIG. 6)

8. In addition to the two legs of the L, each set of grooves has a third leg that runs from a point along the top leg up to the top of the base. (See FIG. 1) This 5 millimeter long groove allows the cap to be removed from the base. Removing the cap allows the whole knife block to be easily washed.

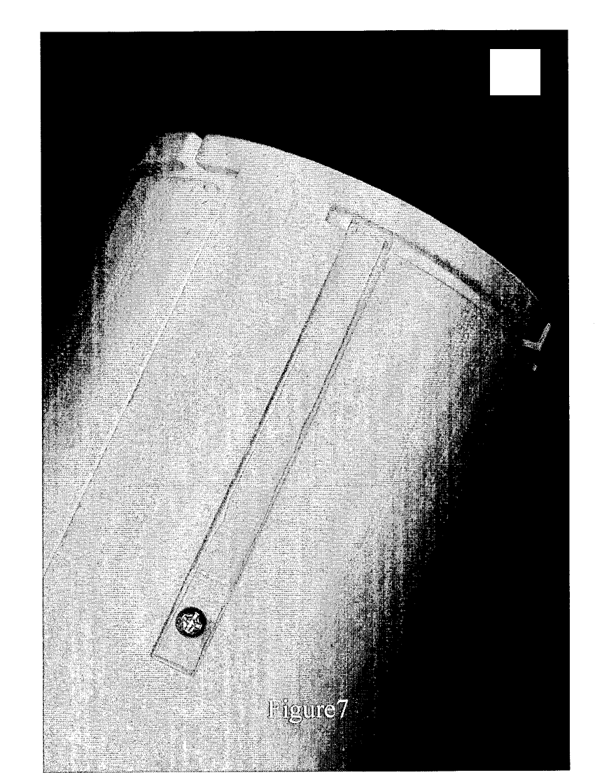

9. Two depressible catch pieces cross two of the top grooves and restrict the movement of the pegs when the block is in the locked position. The catch pieces consist of a long flat stick of the same material as the base. (See FIG. 7) The catches are approximately 15 millimeters wide. The two catch pieces rest in two additional longitudinal grooves. These two grooves are 120 degrees from each other and are located on the back half of the base, opposite the foot. The catches are fixed at their bottoms, and they are thin enough to be flexible. When the catches are in their normal state, they block the top grooves so the pegs cannot pass. When the user presses the catch pieces, they sink into their large grooves, allowing the peg to pass by. When the catch is fully depressed, it is approximately flush with the bottom of the groove. Both catches must be depressed to unlock the block. As noted above, the user depresses the two catch pieces with thumb and forefinger in order to depress them simultaneously and employs the other hand to move the cap.

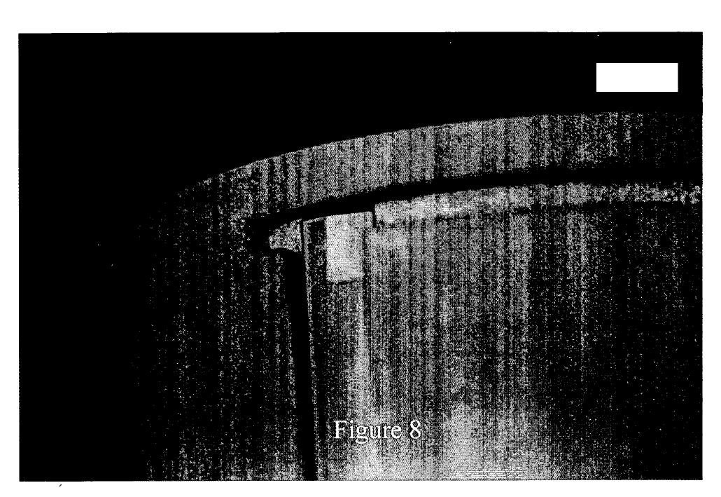

10. A further feature of the catch piece is that it allows the cap pegs to pass when the knife block is being locked, but it stops the pegs when they move in the unlocking direction. The portion of the catch that crosses the top groove is angled as shown in FIG. 8. The side of the catch piece that faces the peg when the cap is in the locked position is the thickest point and is flush with the outer surface of the base piece. The opposite side of the catch is thinner and is flush with the inside of the top groove. As a result, the angling of the catch piece makes it only block the movement of the peg when the user tries to unlock the cap. When the cap is rotated to lock it, the movement of the peg itself depresses the catch and allows the cap to move. Once the peg passes the catch, it returns to its normal un-depressed position, blocking the movement of the peg. The user then has to depress the catch manually to let the pegs past and unlock the knife block.

1. We claim as our invention a knife block that allows the user to lock the knives by the means of a safety cap that is secured in place by depressible catch pieces.
1A. We claim as our invention a knife block with safety cap that can be unlocked by depressing the catch pieces, rotating the cap so that the slots in the cap align with the knives' handles, and lowering the cap so that the knives' handles protrude through the slots in the cap and are accessible.
1B. We claim as our invention a knife block with safety cap that has protrusions or pegs that slide along grooves in the base to guide its movement from locked to unlocked positions and vice versa.

2. We claim as our invention a safety cap that has protrusions or pegs and is designed to fit over a knife block to secure the knives' handles.
